(19) United States
(12) Patent Application Publication
(10) Pub. No.: US 2025/0290528 A1
(43) Pub. Date: Sep. 18, 2025

(54) ONLINE MONITORING SYSTEM AND METHOD FOR HYDRAULIC OIL OF POWER AERIAL WORK VEHICLE, AND DEVICE

(71) Applicant: ELECTRIC POWER RESEARCH INSTITUTE, CHINA SOUTHERN POWER GRID, Guangzhou, Guangdong (CN)

(72) Inventors: Lei LIU, Guangzhou, Guangdong (CN); Ruijian PAN, Guangzhou, Guangdong (CN); Li TANG, Guangzhou, Guangdong (CN); Lei JIA, Guangzhou, Guangdong (CN); Conghan LIU, Guangzhou, Guangdong (CN); Bin LI, Guangzhou, Guangdong (CN); Min LI, Guangzhou, Guangdong (CN); Enwen LI, Guangzhou, Guangdong (CN); Tianwei LI, Guangzhou, Guangdong (CN)

(73) Assignee: ELECTRIC POWER RESEARCH INSTITUTE, CHINA SOUTHERN POWER GRID, Guangzhou, Guangdong (CN)

(21) Appl. No.: 18/860,721

(22) PCT Filed: Jun. 24, 2022
(86) PCT No.: PCT/CN2022/101059

§ 371 Date: Oct. 28, 2024

(30) Foreign Application Priority Data
Apr. 28, 2022 (CN) 202210461333.9

(51) Int. Cl. F15B 19/00

(52) U.S. Cl. CPC F15B 19/005

(57) ABSTRACT

An online monitoring system and method for hydraulic oil of a power aerial work vehicle, and a device. A microprocessor receives a monitoring instruction, and the microprocessor sends an oil extraction signal to a gear pump; then, the gear pump is started after responding to the oil extraction signal, extracts hydraulic oil from a hydraulic oil tank, and conveys same to the hydraulic oil tank by means of a pipeline, wherein the hydraulic oil in the hydraulic oil tank is cyclically extracted; a detection module detects the hydraulic oil in the pipeline in real time, generates oil quality parameters and sends the oil quality parameters to the microprocessor; and the microprocessor compares the received oil quality parameters with preset parameter threshold values, and finally generates oil quality state information and displays same.

The present application claims priority to Chinese Patent Application No. 202210461333.9, titled “ONLINE MONITORING SYSTEM AND METHOD FOR HYDRAULIC OIL OF POWER AERIAL WORK VEHICLE, AND DEVICE”, filed on Apr. 28, 2022 with the China National Intellectual Property Administration, which is incorporated herein by reference in its entirety.

### FIELD

The present disclosure relates to the technical field of monitoring states of power distribution devices, and in particular to an online monitoring system for hydraulic oil of a power aerial work vehicle, an online monitoring method for hydraulic oil of a power aerial work vehicle, and a device.

### BACKGROUND

With the development trend of large, complex, high-speed, and automation of the modern engineering machinery devices, the production efficiency of the devices is improved, and the mechanical structure becomes increasingly complex. With the modern production devices, although labor productivity is greatly improved and manpower and material resources are saved, device maintenance costs are greatly increased and losses caused by device failures per unit of time are exponentially increased.

Taking a power aerial work vehicle as an example, the power aerial work vehicle performs lifting and carrying operations by using a hydraulic system. When the hydraulic system malfunctions or fails, it may directly results in accidents such as work safety. 70% of failures of a hydraulic system are caused by poor management of hydraulic oil. When the work vehicle is operating, a large amount of heat may be generated. Excessive system temperature may cause the hydraulic oil of the power aerial work vehicle to be easily oxidized, increasing the viscosity of the hydraulic oil of the power aerial work vehicle and thereby reducing the anti-wear performance. Solid particle pollution in the hydraulic oil may seriously affect the normal operation of the power aerial work vehicle and even cause accidents.

Therefore, online monitoring is currently not performed on the state of the hydraulic oil of the power aerial work vehicle for maintaining the healthy state of the hydraulic oil, and thus the oil quality of the hydraulic oil cannot be monitor and the state of the hydraulic oil cannot be fed back in real time.

### SUMMARY

According to the present disclosure, an online monitoring system for hydraulic oil of a power aerial work vehicle, an online monitoring method for hydraulic oil of a power aerial work vehicle, and a device are provided, to solve the technical problem that online monitoring is currently not performed on the state of the hydraulic oil of the power aerial work vehicle for maintaining the healthy state of the hydraulic oil and thus the oil quality of the hydraulic oil cannot be monitor and the state of the hydraulic oil cannot be fed back in real time.

In a first aspect of the present disclosure, an online monitoring system for hydraulic oil of a power aerial work vehicle is provided. The online monitoring system includes: a microprocessor, a gear pump and a detection module. The microprocessor is communicatively connected to the gear pump and the detection module. The detection module is connected to a hydraulic oil tank through a pipe, and the gear pump is connected to the hydraulic oil tank through a pipe. The microprocessor is configured to transmit an oil extraction signal to the gear pump in response to a monitoring instruction, compare a received oil parameter with a preset parameter threshold, generate oil quality state information and display the oil quality state information. The gear pump is configured to, in response to the oil extraction signal, extract the hydraulic oil from the hydraulic oil tank and convey the hydraulic oil to the hydraulic oil tank through the pipe. The detection module is configured to detect the hydraulic oil in the pipe in real time, generate the oil parameter, and transmit the oil parameter to the microprocessor.

In an embodiment, the detection module is connected to an inlet of the gear pump through the pipe, and the detection module includes a particle counter and a four-in-one sensor connected through the pipe. The particle counter is configured to detect the number of micron particles in the hydraulic oil in the pipe in real time and transmit the number of the micron particles to the microprocessor. The four-in-one sensor is configured to detect a hydraulic oil viscosity and a hydraulic oil dielectric constant of the hydraulic oil in the pipe in real time, and transmit the hydraulic oil viscosity and the hydraulic oil dielectric constant to the microprocessor.

In an embodiment, the oil parameter includes the number of the micron particles, the hydraulic oil viscosity and the hydraulic oil dielectric constant. The number of the micron particles includes the number of first micron particles and the number of second micron particles. A diameter of a first micron particle is less than a diameter of a second micron particle. The preset parameter threshold includes a first particle number threshold, a preset particle number percentage, a first hydraulic oil viscosity percentage, and a first hydraulic oil relative dielectric constant threshold. The microprocessor is configured to: transmit the oil extraction signal to the gear pump in response to the monitoring instruction; calculate a viscosity change value between the hydraulic oil viscosity and a preset hydraulic oil viscosity; calculate a hydraulic oil relative dielectric constant based on the hydraulic oil dielectric constant; and generate oil quality state information marked as healthy and display the oil quality state information in a case that the number of the first micron particles is less than or equal to the first particle number threshold and an increase in the number of the second micron particles in a first preset time period is less than or equal to the preset particle number percentage and the viscosity change value is less than or equal to the first hydraulic oil viscosity percentage and the hydraulic oil relative dielectric constant is less than or equal to the first hydraulic oil relative dielectric constant threshold.

In an embodiment, the microprocessor is further configured to: generate oil quality state information marked as a first-level warning and display the oil quality state information in a case that the number of the first micron particles is greater than the first particle number threshold or the increase in the number of the second micron particles in the first preset time period is greater than the preset particle number percentage or the viscosity change value is greater than the first hydraulic oil viscosity percentage or the hydraulic oil relative dielectric constant is greater than the first hydraulic oil relative dielectric constant threshold.

In an embodiment, the preset parameter threshold includes a second particle number threshold, a second hydraulic oil viscosity percentage, and a second hydraulic oil relative dielectric constant threshold. The second particle number threshold is greater than the first particle number threshold, the second hydraulic oil viscosity percentage is greater than the first hydraulic oil viscosity percentage, and the second hydraulic oil relative dielectric constant threshold is greater than the first hydraulic oil relative dielectric constant threshold. The microprocessor is further configured to: generate oil quality state information marked as a second-level warning and display the oil quality state information in a case that the number of the first micron particles is greater than the second particle number threshold or the viscosity change value is greater than the second hydraulic oil viscosity percentage or the hydraulic oil relative dielectric constant is greater than the second hydraulic oil relative dielectric constant threshold.

In an embodiment, the detection module is connected to the hydraulic oil tank through a monitoring oil inlet-pipe, and the gear pump is configured to convey the hydraulic oil to the hydraulic oil tank through a monitoring oil return-pipe. The monitoring oil inlet-pipe extends to a bottom of the hydraulic oil tank and an opening at an end of the monitoring oil inlet-pipe faces upward in a “U” shape. The monitoring oil inlet-pipe is horizontally arranged with a curved pipe having a preset length.

In an embodiment, the microprocessor is communicatively connected to a wireless transmission module. The wireless transmission module is configured to transmit the oil quality state information to a user terminal.

In an embodiment, the online monitoring system for hydraulic oil of a power aerial work vehicle further includes an alarm device that is communicatively connected to the microprocessor. The alarm device is configured to receive the oil quality state information and issue a corresponding alarm signal.

In a second aspect of the present disclosure, an online monitoring method for hydraulic oil of a power aerial work vehicle is provided. The online monitoring method includes: transmitting an oil extraction signal to a gear pump in response to a monitoring instruction; extracting hydraulic oil from a hydraulic oil tank and conveying the hydraulic oil to the hydraulic oil tank through a pipe in response to the oil extraction signal; detecting the hydraulic oil in the pipe in real time, generating an oil parameter, and transmitting the oil parameter to a microprocessor; and comparing the oil parameter with a preset parameter threshold, generating oil quality state information, and displaying the oil quality state information.

In a third aspect of the present disclosure, an electronic device is provided. The electronic device includes: a memory and a processor. The memory stores a computer program. The computer program, when being executed by the processor, causes the processor to perform the online monitoring method for hydraulic oil of a power aerial work vehicle described above.

It can be seen from the above technical solutions that the present disclosure has the following advantages.

According to the present disclosure, the microprocessor receives a monitoring instruction and transmits an oil extraction signal to the gear pump. The gear pump starts in response to the oil extraction signal, extracts hydraulic oil from the hydraulic oil tank, and conveys the hydraulic oil to the hydraulic oil tank through the pipe, thereby cyclically extracting the hydraulic oil from the hydraulic oil tank. The detection module detects the hydraulic oil in the pipe in real time, generates an oil parameter, and transmits the oil parameter to the microprocessor. The microprocessor compares the received oil parameter with a preset parameter threshold, generates oil quality state information and displays the oil quality state information. With the microprocessor, the gear pump and the detection module, online monitoring is performed on the oil quality state of hydraulic oil in real time, and oil quality state information is fed back in real time. Based on the displayed oil quality state information, it can be determined whether to replace or filter the hydraulic oil to maintain the hydraulic oil to be in a healthy state, thereby avoiding malfunctions caused by deterioration of the oil quality.

### BRIEF DESCRIPTION OF THE DRAWINGS

In order to clearly illustrate technical solutions in the embodiments of the present disclosure or in the conventional technology, the drawings used in the description of the embodiments or the conventional technology are briefly described below. It is apparent that the drawings in the following description show only some embodiments of the present disclosure, and other drawings may be obtained by those skilled in the art based on the drawings without any creative efforts.

FIG. 1 is a schematic structural diagram of an online monitoring system for hydraulic oil of a power aerial work vehicle according to an embodiment of the present disclosure;

FIG. 2 is a schematic diagram showing a connection between a hydraulic oil tank and a monitoring device according to an embodiment of the present disclosure;

FIG. 3 is a schematic diagram showing a design of an opening of a hydraulic oil tank according to an embodiment of the present disclosure;

FIG. 4 is a schematic structural diagram of a curved pipe according to an embodiment of the present disclosure;

FIG. 5 is a schematic structural diagram of a monitoring device according to an embodiment of the present disclosure;

FIG. 6 is a schematic diagram showing connections between a monitoring device, a hydraulic display controller and a cab display control panel according to an embodiment of the present disclosure;

FIG. 7 is a flowchart of an online monitoring method for hydraulic oil of a power aerial work vehicle according to an embodiment of the present disclosure;

FIG. 8 is a flowchart of an online monitoring method for hydraulic oil of a power aerial work vehicle according to another embodiment of the present disclosure;

FIG. 9 is a flowchart of generating oil quality state information according to an embodiment of the present disclosure; and

FIG. 10 is a schematic structural diagram of an electronic device according to an embodiment of the present disclosure.

Reference numerals are listed as follows:

| | | | |
|---|---|---|---|
| 10 | Hydraulic oil tank | 11 | Air valve |
| 12 | Oil inlet compartment | 13 | Oil tank partition |
| 14 | Oil return compartment | 15 | Monitoring oil return-pipe |
| 16 | Monitoring oil inlet-pipe | 17 | Bolt |
| 20 | Monitoring device | 201 | Tool box |
| 21 | Monitoring oil inlet | 22 | Monitoring oil return port |
| 23 | Oil pipe | 24 | Particle counter |
| 25 | Four-in-one sensor | 26 | Gear pump |
| 27 | Output interface | 28 | Power interface |
| 29 | Spring shock absorber | 30 | Microprocessor |
| 31 | Hydraulic display | 32 | 4G DTU wireless |
| | controller | | transmitter |
| 41 | Hydraulic pressure | 42 | Cab display control |
| | control main switch | | panel |
| 421 | Cab display panel | 422 | Cab start switch |
| 423 | Warning light | 43 | Detection module |

### DETAILED DESCRIPTION OF THE EMBODIMENTS

In order to make the above objectives, features and advantages of the present disclosure more obvious and easier to be understood, technical solutions in the embodiments of the present disclosure are described in detail below with reference to the drawings in the embodiments of the present disclosure. It is apparent that the described embodiments are only some embodiments of the present disclosure, rather than all embodiments. Based on the embodiments in the present disclosure, all other embodiments obtained by those skilled in the art without creative efforts fall within the scope of protection of the present disclosure.

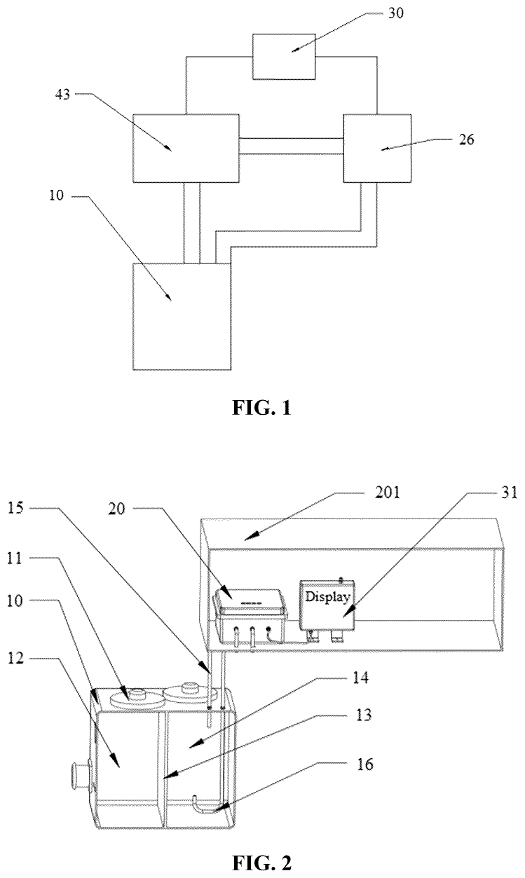

Reference is made to FIG. 1, which is a schematic structural diagram of an online monitoring system for hydraulic oil of a power aerial work vehicle according to an embodiment of the present disclosure.

The online monitoring system for hydraulic oil of a power aerial work vehicle according to the embodiment of the present disclosure includes: a microprocessor 30, a gear pump 26, and a detection module 43. The microprocessor 30 is communicatively connected to the gear pump 26 and the detection module 43. The detection module 43 is connected to a hydraulic oil tank 10 through a pipe, and the gear pump 26 is connected to the hydraulic oil tank 10 through a pipe. The microprocessor 30 is configured to transmit an oil extraction signal to the gear pump 26 in response to a monitoring instruction, compare a received oil parameter with a preset parameter threshold, generate oil quality state information and display the oil quality state information. The gear pump 26 is configured to, in response to the oil extraction signal, extract the hydraulic oil from the hydraulic oil tank 10 and convey the hydraulic oil to the hydraulic oil tank 10 through the pipe. The detection module 43 is configured to detect the hydraulic oil in the pipe in real time, generate the oil parameter, and transmit the oil parameter to the microprocessor 30.

The monitoring instruction is an instruction that can be directly identified by the microprocessor, and is in a form of binary code. The monitoring instruction is transmitted for starting the microprocessor, and then the microprocessor transmits a corresponding oil extraction signal to the gear pump. For example, the functions of the microprocessor includes: receiving and identifying the monitoring instruction; transmitting a corresponding oil extraction signal to the gear pump to control the gear pump to perform the oil extraction operation; receiving oil parameter data collected by the detection module 43, processing the received oil parameters data, and analyzing the oil parameters data to obtain the oil quality state of the hydraulic oil; and the like.

In the embodiment, for example, the oil extraction signal is a switch signal which is used for a certain signal line and has different voltage ranges represent two states of 0 and 1 (or on/off). By inputting the switch signal, the gear pump is controlled to start and perform the oil extraction operation.

The microprocessor is pre-set with a preset parameter threshold corresponding to the oil parameter, and pre-stores a corresponding relationship between comparison results and oil quality states. The comparison results are calculated by comparing the oil parameter with the preset parameter threshold. For example, after receiving the oil parameter, the microprocessor compares the oil parameter with the preset parameter threshold to obtain a comparison result, and then the microprocessor obtains an oil quality state of the hydraulic oil based on the corresponding relationship between the comparison results and the oil quality states.

The gear pump is a type of positive displacement rotary pump, which is generally used to convey liquids with lubricating properties. For example, the gear pump is an electromagnetic gear pump, which extracts the hydraulic oil from the hydraulic oil tank 10 and conveys the hydraulic oil to the hydraulic oil tank 10 through the pipe.

According to the embodiment of the present disclosure, the microprocessor 30 receives a monitoring instruction and transmits an oil extraction signal to the gear pump 26. The gear pump 26 starts in response to the oil extraction signal, extracts hydraulic oil from the hydraulic oil tank 10, and conveys the hydraulic oil to the hydraulic oil tank 10 through the pipe, thereby cyclically extracting the hydraulic oil from the hydraulic oil tank 10. Since the detection module 43, the gear pump 26 and the hydraulic oil tank 10 are connected through pipes, the hydraulic oil is extracted from the hydraulic oil tank 10 and flows through the detection module 43. The detection module 43 detects the hydraulic oil in the pipe in real time, generates an oil parameter, and transmits the oil parameter to the microprocessor 30. The microprocessor 30 compares the received oil parameter with a preset parameter threshold, generates oil quality state information and displays the oil quality state information. With the microprocessor 30, the gear pump 26 and the detection module 43, online monitoring is performed on the oil quality state of hydraulic oil in real time, and oil quality state information is fed back in real time. Based on the displayed oil quality state information, it can be determined whether to replace or filter the hydraulic oil to maintain the hydraulic oil to be in a healthy state, thereby avoiding malfunctions caused by deterioration of the oil quality.

In an embodiment, the detection module 43 is connected to an inlet of the gear pump 26 through the pipe. The detection device is arranged before the inlet of the gear pump 26 to prevent the hydraulic oil from generating bubbles when passing through the gear pump 26 to affect the oil parameter, thereby improving the detection accuracy of the oil parameter. The detection module 43 includes a particle counter 24 and a four-in-one sensor 25 connected through the pipe. The particle counter 24 is configured to detect the number of micron particles in the hydraulic oil in the pipe in real time and transmit the number of the micron particles to the microprocessor 30. The four-in-one sensor 25 is configured to detect a hydraulic oil viscosity and a hydraulic oil dielectric constant of the hydraulic oil in the pipe in real time, and transmit the hydraulic oil viscosity and the hydraulic oil dielectric constant to the microprocessor 30.

It should be noted that the particle counter 24, the four-in-one sensor 25 and the gear pump 26 are connected through oil pipes. The four-in-one sensor 25 includes a density sensor, a viscosity sensor, a dielectric constant sensor and a temperature sensor. Changes in the hydraulic oil viscosity, the hydraulic oil dielectric constant and the number of micron particles in the hydraulic oil significantly affect the oil quality of the hydraulic oil.

In the embodiment of the present disclosure, during the operation of the detection module 43, the particle counter 24 detects the number of micron particles in the hydraulic oil in the pipe in real time and transmits the number of the micron particles to the microprocessor 30, and the four-in-one sensor 25 detects a hydraulic oil viscosity and a hydraulic oil dielectric constant of the hydraulic oil in the pipe in real time and transmits the hydraulic oil viscosity and the hydraulic oil dielectric constant to the microprocessor 30, thereby providing the number of the micro particles, the hydraulic oil viscosity and the hydraulic oil dielectric constant to the microprocessor 30 in real time. Then, the microprocessor 30 may compare the received information of the number of the micron particles, the hydraulic oil viscosity and the hydraulic oil dielectric constant with the preset parameter threshold to determine the oil quality state information of the hydraulic oil in a current state in real time.

Further, the oil parameter includes the number of the micron particles, the hydraulic oil viscosity and the hydraulic oil dielectric constant. The number of the micron particles includes the number of first micron particles and the number of second micron particles. A diameter of a first micron particle is less than a diameter of a second micron particle.

The preset parameter threshold includes a first particle number threshold, a preset particle number percentage, a first hydraulic oil viscosity percentage, and a first hydraulic oil relative dielectric constant threshold.

In an embodiment of the present disclosure, the oil parameter and the parameter threshold may be set to improve the monitoring accuracy. For example, the first micron particles are particles with a diameter of 5 microns to 15 microns, the first micron particles are particles with a diameter greater than 50 microns, the first particle number threshold is 64000, the preset particle number percentage is 15%, the first hydraulic oil viscosity percentage is 10%, and the first hydraulic oil relative dielectric constant threshold is 2.6.

The microprocessor 30 is configured to: transmit the oil extraction signal to the gear pump 26 in response to the monitoring instruction; calculate a viscosity change value between the hydraulic oil viscosity and a preset hydraulic oil viscosity; and calculate a hydraulic oil relative dielectric constant based on the hydraulic oil dielectric constant.

In the embodiments of the present disclosure, the hydraulic oil relative dielectric constant is a ratio of the hydraulic oil dielectric constant to a vacuum dielectric constant. The vacuum dielectric constant, also known as a vacuum permittivity or an electrical constant, is a common electromagnetic physical constant.

In a case that the number of the first micron particles is less than or equal to the first particle number threshold and an increase in the number of the second micron particles in a first preset time period is less than or equal to the preset particle number percentage and the viscosity change value is less than or equal to the first hydraulic oil viscosity percentage and the hydraulic oil relative dielectric constant is less than or equal to the first hydraulic oil relative dielectric constant threshold, oil quality state information marked as healthy is generated and displayed.

In the embodiment of the present disclosure, the detected number of the micron particles of the hydraulic oil, the detected hydraulic oil viscosity and the detected hydraulic oil relative dielectric constant are compared with the preset parameter thresholds, where the hydraulic oil relative dielectric constant may be calculated based on the ratio of the hydraulic oil dielectric constant to the vacuum dielectric constant. In a case that the number of the first micron particles is less than or equal to the first particle number threshold and an increase in the number of the second micron particles in a first preset time period is less than or equal to the preset particle number percentage and the viscosity change value is less than or equal to the first hydraulic oil viscosity percentage (where in calculating the hydraulic oil viscosity, the preset hydraulic oil viscosity is preferably determined as a new hydraulic oil viscosity in specific applications) and the hydraulic oil relative dielectric constant is less than or equal to the first hydraulic oil relative dielectric constant threshold, the microprocessor 30 marks the oil quality state information of the hydraulic oil as a healthy state and displays the oil quality state information. Based on the oil quality state information marked as the healthy state, it is determined that the oil quality is good and the hydraulic oil can be used normally and it is unnecessary to replace or filter the hydraulic oil.

Further, the microprocessor 30 is configured to generate oil quality state information marked as a first-level warning and display the oil quality state information in a case that the number of the first micron particles is greater than the first particle number threshold or the increase in the number of the second micron particles in the first preset time period is greater than the preset particle number percentage or the viscosity change value is greater than the first hydraulic oil viscosity percentage or the hydraulic oil relative dielectric constant is greater than the first hydraulic oil relative dielectric constant threshold.

In the embodiment of the present disclosure, in a case that the oil quality state information marked as the first-level warning is generated and displayed, it is determined that the oil quality exceeds a standard and reaches a state that requires warning attention. In this case, it is required to filter or replace the hydraulic oil timely.

Further, the preset parameter threshold further includes a second particle number threshold, a second hydraulic oil viscosity percentage, and a second hydraulic oil relative dielectric constant threshold. The second particle number threshold is greater than the first particle number threshold, the second hydraulic oil viscosity percentage is greater than the first hydraulic oil viscosity percentage, and the second hydraulic oil relative dielectric constant threshold is greater than the first hydraulic oil relative dielectric constant threshold.

In an embodiment of the present disclosure, the oil parameter and the parameter threshold may be set to improve the monitoring accuracy. For example, the second particle number threshold is 256000, the second hydraulic oil viscosity percentage is 15%, and the second hydraulic oil relative dielectric constant threshold is 4.8.

The microprocessor 30 is further configured to generate oil quality state information marked as a second-level warning and display the oil quality state information in a case that the number of the first micron particles is greater than the second particle number threshold or the viscosity change value is greater than the second hydraulic oil viscosity percentage or the hydraulic oil relative dielectric constant is greater than the second hydraulic oil relative dielectric constant threshold.

In the embodiment of the present disclosure, in a case that the oil quality state information marked as the second-level warning is generated and displayed, it indicates that the hydraulic oil is severely contaminated and the hydraulic oil reaches a state in which the hydraulic oil must be replaced. In this case, it is required to replace the hydraulic oil to avoid malfunctions.

Further, the preset parameter threshold further includes: a first preset increase threshold, a second preset increase threshold, a third preset increase threshold and a fourth preset increase threshold.

The microprocessor 30 is further configured to: generate oil quality state information marked as the first-level warning; calculate an increase in the number of first micron particles, an increase in the number of second micron particles, an increase in the hydraulic oil viscosity and an increase in the hydraulic oil relative dielectric constant in a second preset time period, where the second preset time period is less than the first preset time period; and generate oil quality state information marked as the second-level warning and display the oil quality state information in a case that the increase in the number of first micron particles is greater than the first preset increase threshold or the increase in the number of second micron particles is greater than the second preset increase threshold or the increase in the hydraulic oil viscosity is greater than the third preset increase threshold or the increase in the hydraulic oil relative dielectric constant is greater than the fourth preset increase threshold.

In the embodiment of the present disclosure, in a case that the oil quality state information is the first-level warning, it indicates that it is required to pay attention to the oil quality state of the hydraulic oil. Then, the detection frequency is increased. The increases in the oil parameters are detected and compared with the preset parameter thresholds, then it is determined whether an increase in hydraulic oil in the current state is too large, and then it may be determined in advance whether the oil quality state may switch from the first-level warning state to the second-level warning state, thereby improving the accuracy of monitoring the oil quality state of hydraulic oil.

In the embodiments of the present disclosure, particles with a diameter of 5 microns to 15 microns and particles with a diameter greater than 50 microns significantly affect the oil quality. Preferably, the first particle number threshold is set to 64000, the second particle number threshold is set to 256000, the preset particle number percentage is set to 15%, the first hydraulic oil viscosity percentage is set to 10%, the second hydraulic oil viscosity percentage is set to 15%, the first hydraulic oil relative dielectric constant threshold is set to 2.6, and the second hydraulic oil relative dielectric constant threshold is set to 4.8. In practice, the monitoring accuracy of the oil quality state is improved based on the preset parameter thresholds.

In an embodiment, the detection module 43 is connected to the hydraulic oil tank 10 through a monitoring oil inlet-pipe 16, and the gear pump 26 is configured to convey the hydraulic oil to the hydraulic oil tank 10 through a monitoring oil return-pipe 15. The monitoring oil inlet-pipe 16 extends to a bottom of the hydraulic oil tank 10 and an opening at an end of the monitoring oil inlet-pipe faces upward in a “U” shape, and the monitoring oil inlet-pipe 16 is horizontally arranged with a curved pipe having a preset length.

It should be noted that hydraulic oil tank 10 includes an oil inlet compartment 12 and an oil return compartment 14 separated by an oil tank partition 13. The monitoring device 20 is connected to the oil return compartment 14 through a pipe to avoid affecting the normal operation of the hydraulic system when the monitoring device detects the hydraulic oil. A connection point between the monitoring device 20 and the hydraulic oil tank 10 is fixed by using a bolt 17. A top of the hydraulic oil tank 10 is arranged with an air valve 11.

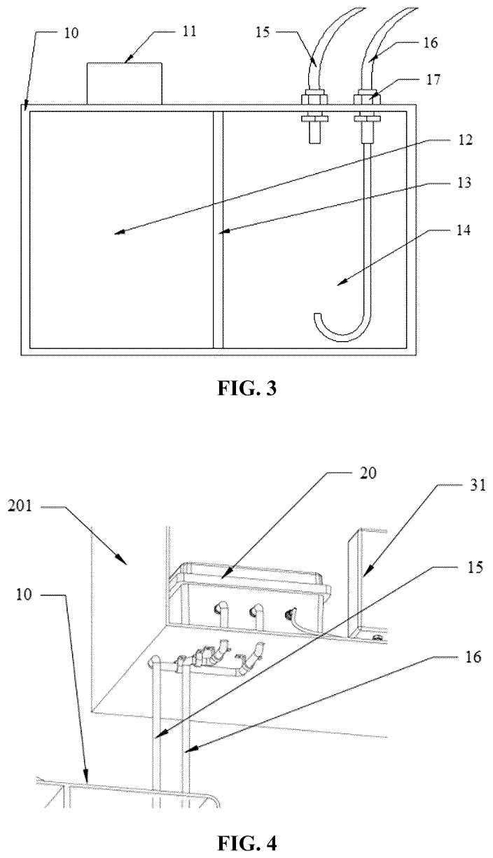

FIG. 3 shows a schematic diagram of a design of an opening of a hydraulic oil tank. In an embodiment of the present disclosure, the monitoring oil inlet-pipe 16 is extended to the bottom of the hydraulic oil tank 10 and the opening at the end of the monitoring oil inlet-pipe 16 faces upward in a “U” shape. With the opening at the end of the monitoring oil inlet-pipe 16 faces upward in the “U” shape, it is less likely to extract oil sludge and impurities accumulated at the bottom of the hydraulic oil tank 10, to avoid blocking the oil pipe and extend the service life of the gear pump 26. When the hydraulic mechanism of the vehicle operates normally, the hydraulic oil may flow back from the top to the hydraulic oil tank 10. Thus, the opening at the end of the monitoring oil inlet-pipe 16 is arranged to face upward, so that it can be ensured to extract more oil in the normal use circulation which may better represent the quality of the oil. In addition, the opening at the end of the monitoring oil inlet-pipe 16 is arranged at a position slightly below the middle of the oil, avoiding the empty pumping of the gear pump 26 due to insufficient oil remained in the oil tank during the normal operation of the hydraulic mechanism of the vehicle.

FIG. 4 shows a schematic structural diagram of curved pipes. In practical implementation, without monitoring the hydraulic oil, the hydraulic oil in the monitoring oil inlet-pipe 16 may flow back to the hydraulic oil tank 10 under the action of gravity. When the gear pump 26 begins to pump the oil through the monitoring inlet-pipe 16, the gear pump 26 may first pump out some air, resulting in an idle time period. A long idle time period may affect the service life of the gear pump 26. Therefore, with the arranged curved pipes, the flowing back hydraulic oil may trap in the curved pipes due to the viscosity of the hydraulic oil. Thus, when gear pump 26 begins to pump, the gear pump 26 may first extract the hydraulic oil trapped in the pipes, thereby preventing the gear pump 26 from idling for a long time and improving the service life of the gear pump 26.

Further, the online monitoring system for hydraulic oil of a power aerial work vehicle includes an alarm device which is communicatively connected to the microprocessor 30. The alarm device is configured to receive the oil quality state information and issues a corresponding alarm signal.

In practice, when the oil quality state information is healthy, the alarm device does not issue an alarm signal; when the oil quality state information is the first-level warning, the alarm device issues intermittent alarm prompts; and when the oil quality state information is the second-level warning, the alarm device issues a continuous alarm prompt until the second-level warning state is lifted.

In an embodiment, the microprocessor 30, the gear pump 26 and the detection module 43 are all arranged in the monitoring device 20, which is convenient for management and viewing (as shown in FIG. 2). The monitoring device 20 is provided with an output interface 27. The gear pump 26 and the detection module 43 are communicatively connected to the microprocessor 30 through the output interface 27 of the monitoring device 20. The microprocessor 30 is further connected to a hydraulic display controller 31, and the oil quality state information is displayed by the hydraulic display controller 31. In addition, the hydraulic display controller 31 may further display the oil parameter information. The hydraulic display controller 31 is provided with an oil pressure control main switch 41 for controlling the monitoring device 20 to be opened and closed. The monitoring device 20 and the hydraulic display controller 31 are both arranged in a tool box 201 equipped on the power aerial work vehicle, which is convenient for management and viewing. The monitoring device 20 is further provided with a monitoring oil inlet 21 and a monitoring oil return port 22. An end of the monitoring oil inlet 21 is connected to the monitoring oil inlet-pipe 16 for the hydraulic oil to enter the monitoring device 20, and an end of the monitoring oil return port 22 is connected to the monitoring oil return-pipe 15 for the hydraulic oil to be outputted from the monitoring device 20. An end of the monitoring oil inlet 21 is connected to the detection module 43 through the oil pipe 23, and an end of the monitoring oil return port is connected to an outlet of the gear pump 26 through the oil pipe 23. Preferably, the monitoring module is connected to the inlet of the gear pump through the oil pipe 23. The monitoring device 20 is further provided with a shock absorber, preferably a spring shock absorber 29. With the spring shock absorber 29, the impact of hydraulic oil bubbles in the pipes caused by the vibration of the monitoring device 20 during high-altitude power operations on the detection accuracy can be avoided.

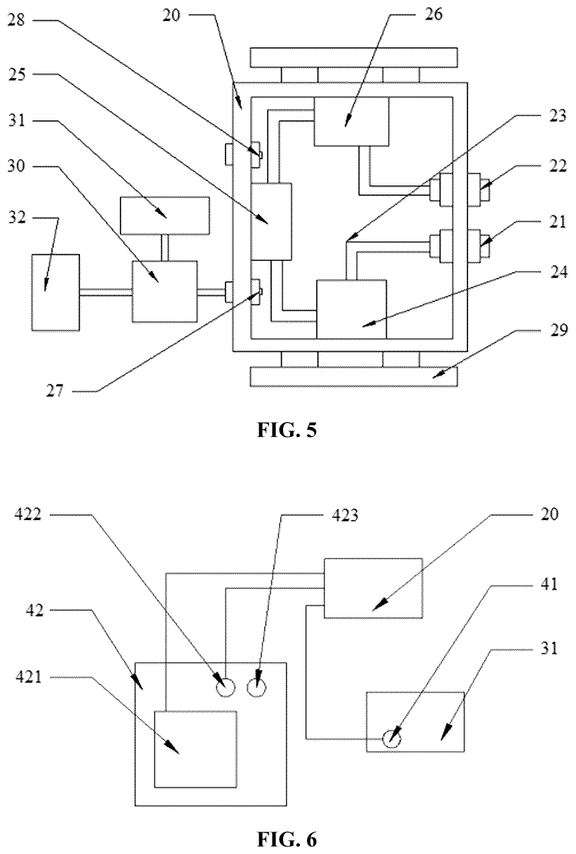

FIG. 5 shows a schematic structural diagram of a monitoring device 20. It should be noted that the monitoring device 20 is further provided with a power interface 28 for providing electrical energy to the monitoring device. In an embodiment of the present disclosure, the gear pump 26 and the detection module 43 are integrated in the monitoring device 20, facilitating management and maintenance of the monitoring device 20. In addition, the microprocessor 30 is communicatively connected to the hydraulic display controller 31, facilitating the viewing of the oil quality state and the oil parameters. The monitoring device 20 is controlled to be opened and closed, thereby performing online monitoring on the oil quality state of the hydraulic oil and avoiding faults caused by changes of the oil quality state.

Further, the microprocessor 30 is communicatively connected with a wireless transmission module. The wireless transmission module is configured to transmit the oil quality state information to a user terminal.

In an embodiment of the present disclosure, the wireless transmission module includes a 4G DTU wireless transmitter 32 (which may further be a wireless WiFi transmitter), which transmits the oil quality state information, the oil parameters and the like to the user terminal, such as a mobile phone, a computer and other devices, in a wireless transmission manner, thereby performing remote online monitoring on the oil state of the hydraulic oil.

Further, the oil parameter includes hydraulic oil temperature information. The temperature of the hydraulic oil significantly affects the viscosity of the hydraulic oil, and changes in the temperature of the hydraulic oil may indirectly lead to changes of the oil quality state.

Further, the microprocessor 30 is connected to a cab display control panel 42 arranged in a cab of the power aerial work vehicle. The cab display control panel 42 includes a cab display panel 421, a cab start switch 422, and a warning light 423.

It should be noted that the hydraulic control main switch 41 and the cab start switch 422 have the same function and are interlocked with each other. Preferably, when the hydraulic control main switch 41 is activated, the cab start switch 422 fails, and the hydraulic control main switch 41 has a priority authority.

FIG. 6 shows a schematic diagram showing connections between a monitoring device, a hydraulic display controller and a cab display control panel. In an embodiment of the present disclosure, the oil quality state of the hydraulic oil may be directly viewed in the cab through the cab display control panel 42. The warning light 423 is configured to cooperate with the alarm device to issue a warning based on the oil quality state of the hydraulic oil. The warning light 423 shows a green light when the oil quality state information is healthy; the warning light 423 shows a yellow light when the oil quality state information is the first-level warning; and the warning light 423 shows a red light when the oil quality state information is the second-level warning. Thus, the oil quality state information of the hydraulic oil can be easily and quickly obtained during operations, and then timely response to the changes in the oil quality state of the hydraulic oil can be performed, thereby avoiding faults.

In the embodiments of the present disclosure, the detection module 43 is arranged before the inlet of the gear pump 26, the detection module 43 and the gear pump 26 are arranged in the monitoring device 20, and the shock absorber is arranged at the monitoring device 20 and the end of the monitoring oil inlet-pipe 16 is arranged in the “U” shape, avoiding the to-be-detected hydraulic oil containing bubbles or impurities, thereby improving the detection accuracy of the hydraulic oil. In addition, the microprocessor 30 is connected to external device, such as transmitting data to a user terminal through a wireless transmission module, and the oil quality state of the hydraulic oil is monitored online through the cab display control panel 42, the hydraulic display controller 31 and the like, facilitating timely obtaining the oil quality state of the hydraulic oil and thereby avoiding malfunctions. Furthermore, in comparing the oil parameters, the determination is performed based on the number of the first micron particles, the number of the second micron particles, the hydraulic oil viscosity and the hydraulic oil relative dielectric constant (where the hydraulic oil relative dielectric constant may be calculated based on the ratio of the hydraulic oil dielectric constant to the vacuum dielectric constant) in the oil parameters. In practice, the parameter thresholds may be configured. When the number of the first micron particles is set to be the number of particles with a diameter of 5 microns to 15 microns and the number of the second micron particle is set to be the number of particles with a diameter greater than 50 microns, the oil quality is greatly affected. Specifically, the first particle number threshold is set to 64000, the second particle number threshold is set to 256000, the preset particle number percentage is set to 15%, the first hydraulic oil viscosity percentage is set to 10%, the second hydraulic oil viscosity percentage is set to 15%, the first hydraulic oil relative dielectric constant threshold is set to 2.6, and the second hydraulic oil relative dielectric constant threshold is set to 4.8. With the preset parameter thresholds, the monitoring accuracy of the oil quality state can be further improved. Based on the multiple oil quality states, buffer zones for determining the oil quality state are added, and the changes in the oil quality state can be noticed in advance, thereby improving the effectiveness of online monitoring of the oil quality state of the hydraulic oil to avoid faults caused by deterioration of the oil quality state.

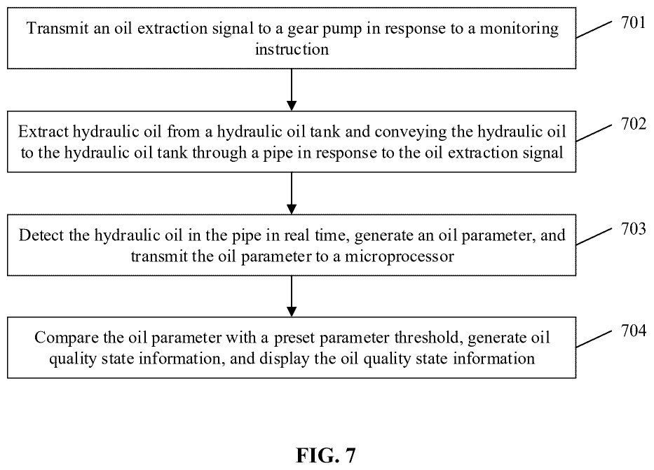

Reference is made to FIG. 7, which is a flowchart of an online monitoring method for hydraulic oil of a power aerial work vehicle according to an embodiment of the present disclosure.

The online monitoring method for hydraulic oil of a power aerial work vehicle according to the present disclosure includes the following steps 701 to 704.

In step 701, an oil extraction signal is transmitted to a gear pump in response to a monitoring instruction.

In step 702, hydraulic oil is extracted from a hydraulic oil tank and the hydraulic oil is conveyed to the hydraulic oil tank through a pipe in response to the oil extraction signal.

In step 703, the hydraulic oil in the pipe is detected in real time, an oil parameter is generated, and the oil parameter is transmitted to a microprocessor.

In step 704, the received oil parameter is compared with a preset parameter threshold, and oil quality state information is generated and displayed.

According to the embodiment of the present disclosure, after the system receives a monitoring instruction, the microprocessor transmits an oil extraction signal to the gear pump. Then, in response to the oil extraction signal, hydraulic oil is extracted from the hydraulic oil tank and is conveyed to the hydraulic oil tank through the pipe, thereby cyclically extracting the hydraulic oil from the hydraulic oil tank. The hydraulic oil in the pipe is detected in real time, and an oil parameter is generated and transmitted to the microprocessor. Then, the received oil parameter is compared with a preset parameter threshold, and oil quality state information is generated and displayed. Therefore, online monitoring is performed on the oil quality state of hydraulic oil in real time, and oil quality state information is fed back in real time. Based on the displayed oil quality state information, it can be determined whether to replace or filter the hydraulic oil to maintain the hydraulic oil to be in a healthy state, thereby avoiding malfunctions caused by deterioration of the oil quality.

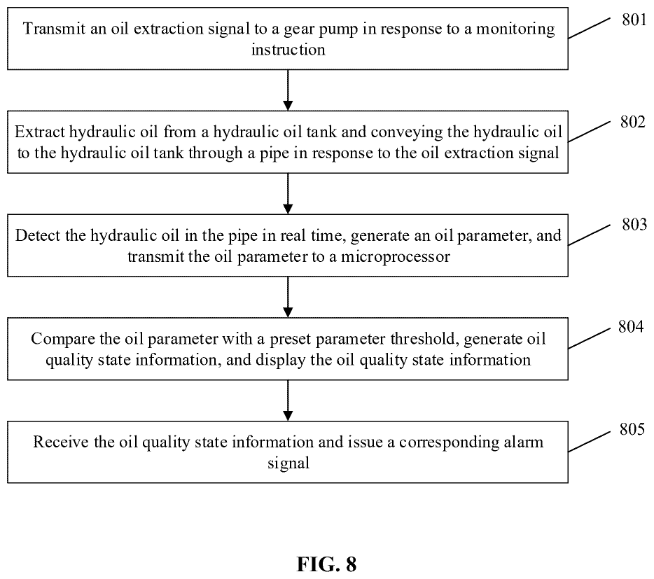

Reference is made to FIG. 8, which is a flowchart of an online monitoring method for hydraulic oil of a power aerial work vehicle according to another embodiment of the present disclosure.

The online monitoring method for hydraulic oil of a power aerial work vehicle according to another embodiment of the present disclosure includes the following steps 801 to 805.

In step 801, an oil extraction signal is transmitted to a gear pump in response to a monitoring instruction.

In step 802, hydraulic oil is extracted from a hydraulic oil tank and the hydraulic oil is conveyed to the hydraulic oil tank through a pipe in response to the oil extraction signal.

In the embodiments of the present disclosure, the implementation processes of steps 801 and 802 are similar to the implementation processes of steps 701 and 702, and are not repeated herein.

In step 803, the hydraulic oil in the pipe is detected in real time, an oil parameter is generated, and the oil parameter is transmitted to a microprocessor.

In an embodiment, the step 803 further includes: detecting the number of first micron particles, the number of second micron particles, a hydraulic oil viscosity and a hydraulic oil dielectric constant from the hydraulic oil in the pipe in real time, and transmitting the number of first micron particles, the number of second micron particles, the hydraulic oil viscosity and the hydraulic oil dielectric constant to the microprocessor.

In the embodiments of the present disclosure, the number of first micron particles, the number of second micron particles, the hydraulic oil viscosity and the hydraulic oil dielectric constant that are detected from the hydraulic oil in the oil pipe are important indicators for determining the oil quality state information.

In an embodiment, the detecting the number of first micron particles, the number of second micron particles, a hydraulic oil viscosity and a hydraulic oil dielectric constant from the hydraulic oil in the pipe in real time and transmitting the number of the first micron particles, the number of the second micron particles, the hydraulic oil viscosity and the hydraulic oil dielectric constant to the microprocessor includes: detecting the number of particles with a diameter of 5 microns to 15 microns, the number of particles with a diameter greater than 50 microns, the hydraulic oil viscosity and the hydraulic oil dielectric constant from the hydraulic oil in the pipe in real time, and transmitting the number of the particles, the hydraulic oil viscosity and the hydraulic oil dielectric constant to the microprocessor.

In the embodiment of the present disclosure, the number of the particles with the diameter of 5 microns to 15 microns, the number of the particles with the diameter greater than 50 microns, the hydraulic oil viscosity and the hydraulic oil dielectric constant are important indicators for determining the oil quality state information.

In step 804, the received oil parameter is compared with a preset parameter threshold, and oil quality state information is generated and displayed.

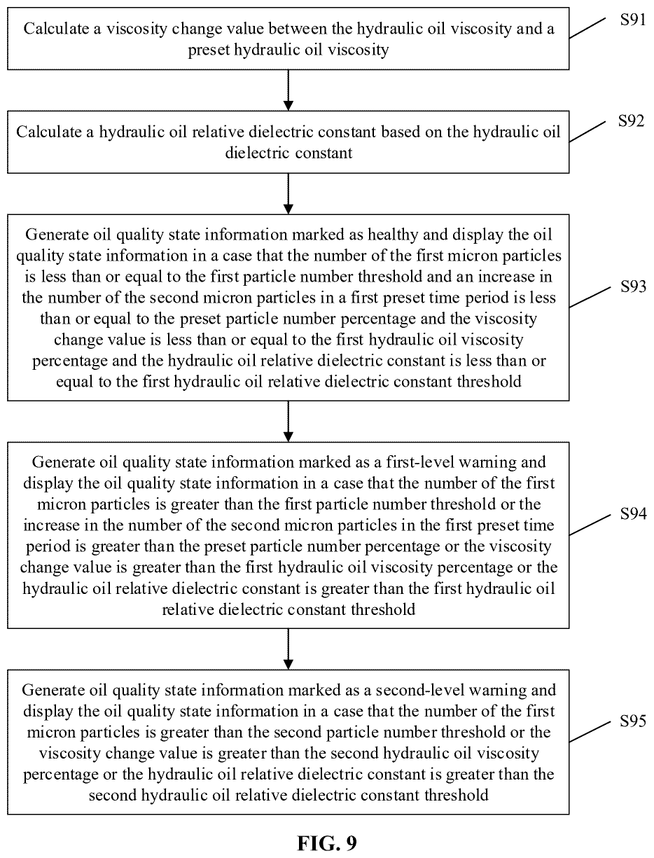

In an embodiment, the step 804 may include the following steps S91 to S95 (as shown in FIG. 9).

In step S91, a viscosity change value between the hydraulic oil viscosity and a preset hydraulic oil viscosity is calculated.

It should be noted that in applications, the preset hydraulic oil viscosity is the hydraulic oil viscosity of new oil inputted into the hydraulic oil tank, ensuring that the parameter value is inputted according to actual situations, and thereby improving the monitoring accuracy of the oil quality state.

In step S92, a hydraulic oil relative dielectric constant is calculated based on the hydraulic oil dielectric constant.

It should be noted that the hydraulic oil relative dielectric constant may be calculated based on the ratio of the hydraulic oil dielectric constant to the vacuum dielectric constant.

In step S93, oil quality state information marked as healthy is generated and displayed in a case that the number of the first micron particles is less than or equal to the first particle number threshold and an increase in the number of the second micron particles in a first preset time period is less than or equal to the preset particle number percentage and the viscosity change value is less than or equal to the first hydraulic oil viscosity percentage and the hydraulic oil relative dielectric constant is less than or equal to the first hydraulic oil relative dielectric constant threshold.

In step S94, oil quality state information marked as a first-level warning is generated and displayed in a case that the number of the first micron particles is greater than the first particle number threshold or the increase in the number of the second micron particles in the first preset time period is greater than the preset particle number percentage or the viscosity change value is greater than the first hydraulic oil viscosity percentage or the hydraulic oil relative dielectric constant is greater than the first hydraulic oil relative dielectric constant threshold.

In step S95, oil quality state information marked as a second-level warning is generated and displayed in a case that the number of the first micron particles is greater than the second particle number threshold or the viscosity change value is greater than the second hydraulic oil viscosity percentage or the hydraulic oil relative dielectric constant is greater than the second hydraulic oil relative dielectric constant threshold.

In the embodiments of the present disclosure, the determination is performed based on the number of the first micron particles, the number of the second micron particles, the hydraulic oil viscosity and the hydraulic oil relative dielectric constant in the oil parameters to improve the monitoring accuracy of the oil quality state, and corresponding oil quality state information is generated and displayed for easy viewing and timely obtaining of the oil quality state, so as to ensure the healthy state of the hydraulic oil.

Further, the step S93 includes: generating the oil quality state information marked as healthy and displaying the oil quality state information in a case that the number of particles with a diameter of 5 microns to 15 microns is less than or equal to 64000 and an increase in the number of particles with a diameter greater than 50 microns in a first preset time period is less than or equal to 15% and the viscosity change value is less than or equal to 10% and the hydraulic oil relative dielectric constant is less than or equal to 2.6.

The step S94 includes: generating the oil quality state information marked as the first-level warning and displaying the oil quality state information in a case that the number of particles with the diameter of 5 microns to 15 microns is greater than 64000 or the increase in the number of particles with the diameter greater than 50 microns in the first preset time period is greater than 15% or the viscosity change value is greater than 10% or the hydraulic oil relative dielectric constant is greater than 2.6.

The step S95 includes: generating the oil quality state information marked as the second-level warning and displaying the oil quality state information in a case that the number of particles with the diameter of 5 microns to 15 microns is greater than 256000 or the viscosity change value is greater than 15% or the hydraulic oil relative dielectric constant is greater than 4.8.

In the embodiments of the present disclosure, particles with a diameter of 5 microns to 15 microns and particles with a diameter greater than 50 microns significantly affect the oil quality. Preferably, the first particle number threshold is set to 64000, the second particle number threshold is set to 256000, the preset particle number percentage is set to 15%, the first hydraulic oil viscosity percentage is set to 10%, the second hydraulic oil viscosity percentage is set to 15%, the first hydraulic oil relative dielectric constant threshold is set to 2.6, and the second hydraulic oil relative dielectric constant threshold is set to 4.8. In practice, the monitoring accuracy of the oil quality state is improved based on the preset parameter thresholds.

Further, the step S92 includes the following steps S921 and S922.

In step S921, an increase in the number of first micron particles, an increase in the number of second micron particles, an increase in the hydraulic oil viscosity and an increase in the hydraulic oil relative dielectric constant in a second preset time period are calculated. The second preset time period is less than the first preset time period.

In step S922, oil quality state information marked as the second-level warning is generated and displayed in a case that the increase in the number of first micron particles is greater than the first preset increase threshold or the increase in the number of second micron particles is greater than the second preset increase threshold or the increase in the hydraulic oil viscosity is greater than the third preset increase threshold or the increase in the hydraulic oil relative dielectric constant is greater than the fourth preset increase threshold.

In the embodiment of the present disclosure, in a case that the oil quality state information is the first-level warning, it indicates that it is required to pay attention to the oil quality state of the hydraulic oil. Then, the detection frequency is increased. The increases in the oil parameters are detected and compared with the preset parameter thresholds, then it is determined whether an increase in hydraulic oil in the current state is too large, and then it may be determined in advance whether the oil quality state may switch from the first-level warning state to the second-level warning state, thereby improving the accuracy of monitoring the oil quality state of hydraulic oil.

Further, the step S921 includes: calculating an increase in the number of the particles with the diameter of 5 microns to 15 microns, an increase in the number of the particles with the diameter greater than 50 microns, the increase in the hydraulic oil viscosity and the increase in the hydraulic oil relative dielectric constant in the second preset time period. The second preset time period is less than the first preset time period.

The step S922 includes: generating the oil quality state information marked as the second-level warning and displaying the oil quality state information in a case that the increase in the number of the particles with the diameter of 5 microns to 15 microns is greater than the first preset increase threshold or the increase in the number of the particles with the diameter greater than 50 microns is greater than the second preset increase threshold or the increase in the hydraulic oil viscosity is greater than the third preset increase threshold or the increase in the hydraulic oil relative dielectric constant is greater than the fourth preset increase threshold.

It should be noted that the number of the particles with the diameter of 5 microns to 15 microns and the number of the particles with the diameter greater than 50 microns significantly affect the oil quality state. Therefore, the first micron particles are set to be the particles with the diameter of 5 microns to 15 microns and the second micron particles are set to be the particles with the diameter greater than 50 microns for determination.

In step 805, the oil quality state information is received, and a corresponding alarm signal is issued.

In the embodiment of the present disclosure, the system receives the oil quality state and issues a corresponding alarm signal. When the oil quality state information is healthy, the alarm device does not issue an alarm signal and the warning light shows a green light; when the oil quality state information is the first-level warning, the alarm device issues intermittent alarm prompts and the warning light shows a yellow light; and when the oil quality state information is the second-level warning, the alarm device issues a continuous alarm prompt and the warning light shows a red light until the second-level warning state is lifted.

In the embodiments of the present disclosure, the determination is performed based on the number of the first micron particles, the number of the second micron particles, the hydraulic oil viscosity and the hydraulic oil relative dielectric constant in the oil parameters, improving the monitoring accuracy of the oil quality state. In practical applications, the parameter thresholds are configured. The particles with a diameter of 5 microns to 15 microns and the particles with a diameter greater than 50 microns greatly affect the oil quality. Preferably, the first particle number threshold is set to 64000, the second particle number threshold is set to 256000, the preset particle number percentage is set to 15%, the first hydraulic oil viscosity percentage is set to 10%, the second hydraulic oil viscosity percentage is set to 15%, the first hydraulic oil relative dielectric constant threshold is set to 2.6, and the second hydraulic oil relative dielectric constant threshold is set to 4.8. With the preset parameter thresholds, the monitoring accuracy of the oil quality state can be further improved. Based on the multiple oil quality states, buffer zones for determining the oil quality state are added, and the changes in the oil quality state can be noticed in advance, thereby improving the effectiveness of online monitoring of the oil quality state of the hydraulic oil to avoid faults caused by deterioration of the oil quality state.

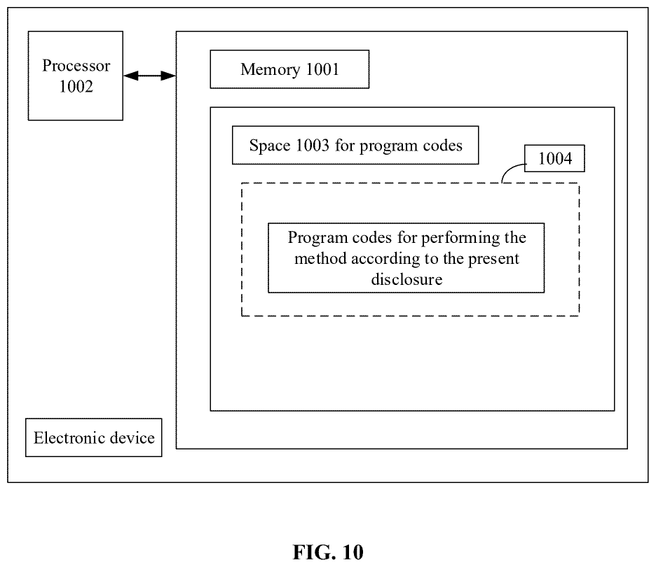

Reference is made to FIG. 10, which is a schematic structural diagram of an electronic device according to an embodiment of the present disclosure.

An electronic device is provided according to an embodiment of the present disclosure. The electronic device includes: a memory 1001 and a processor 1002. The memory 1001 stores a computer program. The computer program, when being executed by the processor 1002, causes the processor 1002 to perform the online monitoring method for hydraulic oil of a power aerial work vehicle described in any one of the above embodiments.

The memory 1001 may be an electronic memory such as a flash memory, an electrically erasable programmable read only memory (EEPROM), an electrically programmable read only memory (EPROM), a hard disk, or a read only memory (ROM). The memory 1001 has a storage space 1003 for storing program codes 1004 for performing any of the steps in the above method. For example, the storage space 1003 for storing the program codes may include various program codes 904 for implementing the steps in the above methods. The program codes may be read from or written to one or more computer program products. The computer program products include hard disks, compact disks (CDs), memory cards, floppy disks or other carriers for storing program codes. The program codes may be, for example, compressed in a suitable form. The codes, when being executed by a computing and processing device, cause the computing and processing device to perform the online monitoring method for hydraulic oil of a power aerial work vehicle described above.

Those skilled in the art may clearly understand that, for convenience and brevity of description, detailed operating processes of the foregoing system, device and unit may refer to corresponding processes in the foregoing method embodiments, and are not repeated herein.

In the embodiments of the present disclosure, it should be understood that the disclosed system, method and electronic device may be implemented in other ways. For example, the device embodiments described above are only illustrative. For example, the division of the units is only a logical function division. In practice, there may be other division manners such as multiple units or components may be combined or integrated into another system, or some features may be ignored or not executed. In addition, the couplings or direct couplings or communication connections shown or discussed may be indirect couplings or communication connections through some interfaces, devices or units, and may be in electrical, mechanical or in other forms.

The units described as separate components may or may not be physically separated, and the components shown as units may or may not be physical units, that is, the components may be located in one place or distributed at multiple network units. Some or all of the units may be selected according to actual requirements to achieve the purpose of the solutions of the embodiments.

In addition, the function units in the embodiments of the present disclosure may be integrated in one processing unit, may be independently physical units, or two or more units may be integrated in one unit. The integrated unit may be implemented in a form of hardware, or in a form of a software function unit.

In a case that the integrated unit is implemented in the form of a software functional unit and is sold or used as an independent product, the integrated unit may be stored in a computer-readable storage medium. Based on the above understanding, the essence part or the part contributing to the conventional technology of the technical solutions of the present disclosure, or all of or a part of the technical solutions may be embodied by a software product. The software product is stored in a storage medium and includes several instructions for causing a computer device (which may be a personal computer, a server, a network device and so on) to perform all or a part of the steps of the methods according to the embodiments of the present disclosure. The foregoing storage medium includes: a U disk, a removable hard disk, a read-only memory (ROM), a random access memory (RAM), a magnetic disk, an optical disk, or other media that can store program codes.

In summary, the above embodiments are only for illustrating the technical solutions of the present disclosure, and are not intended to limit the present disclosure. Although the present disclosure is illustrated in detail with reference to the embodiments described above, it should be understood by those skilled in the art that modification may be made to the technical solutions recited in the embodiments described above, or equivalent substitution may be made to a part of technical features of the technical solutions. The modifications and equivalent replacements do not make the corresponding technical solutions deviate from the scope of the technical solutions in the embodiments of the present disclosure.

1. An online monitoring system for hydraulic oil of a power aerial work vehicle, comprising:
a microprocessor;
a gear pump; and
a detection module, wherein
the microprocessor is communicatively connected to the gear pump and the detection module, the detection module is connected to a hydraulic oil tank through a pipe, and the gear pump is connected to the hydraulic oil tank through a pipe;
the microprocessor is configured to transmit an oil extraction signal to the gear pump in response to a monitoring instruction, compare a received oil parameter with a preset parameter threshold, generate oil quality state information and display the oil quality state information;
the gear pump is configured to, in response to the oil extraction signal, extract the hydraulic oil from the hydraulic oil tank and convey the hydraulic oil to the hydraulic oil tank through the pipe; and
the detection module is configured to detect the hydraulic oil in the pipe in real time, generate the oil parameter, and transmit the oil parameter to the microprocessor.

2. The online monitoring system for hydraulic oil of a power aerial work vehicle according to claim 1, wherein
the detection module is connected to an inlet of the gear pump through the pipe, and the detection module comprises a particle counter and a four-in-one sensor connected through the pipe;
the particle counter is configured to detect the number of micron particles in the hydraulic oil in the pipe in real time and transmit the number of the micron particles to the microprocessor; and
the four-in-one sensor is configured to detect a hydraulic oil viscosity and a hydraulic oil dielectric constant of the hydraulic oil in the pipe in real time, and transmit the hydraulic oil viscosity and the hydraulic oil dielectric constant to the microprocessor.

3. The online monitoring system for hydraulic oil of a power aerial work vehicle according to claim 1, wherein
the oil parameter comprises the number of the micron particles, the hydraulic oil viscosity and the hydraulic oil dielectric constant, the number of the micron particles comprises the number of first micron particles and the number of second micron particles, and a diameter of a first micron particle is less than a diameter of a second micron particle;
the preset parameter threshold comprises a first particle number threshold, a preset particle number percentage, a first hydraulic oil viscosity percentage, and a first hydraulic oil relative dielectric constant threshold; and
the microprocessor is configured to:
transmit the oil extraction signal to the gear pump in response to the monitoring instruction;
calculate a viscosity change value between the hydraulic oil viscosity and a preset hydraulic oil viscosity;
calculate a hydraulic oil relative dielectric constant based on the hydraulic oil dielectric constant; and
generate oil quality state information marked as healthy and display the oil quality state information in a case that the number of the first micron particles is less than or equal to the first particle number threshold and an increase in the number of the second micron particles in a first preset time period is less than or equal to the preset particle number percentage and the viscosity change value is less than or equal to the first hydraulic oil viscosity percentage and the hydraulic oil relative dielectric constant is less than or equal to the first hydraulic oil relative dielectric constant threshold.

4. The online monitoring system for hydraulic oil of a power aerial work vehicle according to claim 3, wherein the microprocessor is further configured to:
generate oil quality state information marked as a first-level warning and display the oil quality state information in a case that the number of the first micron particles is greater than the first particle number threshold or the increase in the number of the second micron particles in the first preset time period is greater than the preset particle number percentage or the viscosity change value is greater than the first hydraulic oil viscosity percentage or the hydraulic oil relative dielectric constant is greater than the first hydraulic oil relative dielectric constant threshold.

5. The online monitoring system for hydraulic oil of a power aerial work vehicle according to claim 3, wherein
the preset parameter threshold further comprises a second particle number threshold, a second hydraulic oil viscosity percentage, and a second hydraulic oil relative dielectric constant threshold; and the second particle number threshold is greater than the first particle number threshold, the second hydraulic oil viscosity percentage is greater than the first hydraulic oil viscosity percentage, and the second hydraulic oil relative dielectric constant threshold is greater than the first hydraulic oil relative dielectric constant threshold; and
the microprocessor is further configured to:
generate oil quality state information marked as a second-level warning and display the oil quality state information in a case that the number of the first micron particles is greater than the second particle number threshold or the viscosity change value is greater than the second hydraulic oil viscosity percentage or the hydraulic oil relative dielectric constant is greater than the second hydraulic oil relative dielectric constant threshold.

6. The online monitoring system for hydraulic oil of a power aerial work vehicle according to claim 2, wherein
the detection module is connected to the hydraulic oil tank through a monitoring oil inlet-pipe, the gear pump is configured to convey the hydraulic oil to the hydraulic oil tank through a monitoring oil return-pipe, the monitoring oil inlet-pipe extends to a bottom of the hydraulic oil tank and an opening at an end of the monitoring oil inlet-pipe faces upward in a “U” shape, and the monitoring oil inlet-pipe is horizontally arranged with a curved pipe having a preset length.

7. The online monitoring system for hydraulic oil of a power aerial work vehicle according to claim 1, wherein
the microprocessor is communicatively connected to a wireless transmission module; and
the wireless transmission module is configured to transmit the oil quality state information to a user terminal.

8. The online monitoring system for hydraulic oil of a power aerial work vehicle according to claim 1, further comprising:
an alarm device, communicatively connected to the microprocessor, wherein
the alarm device is configured to receive the oil quality state information and issue a corresponding alarm signal.

9. An online monitoring method for hydraulic oil of a power aerial work vehicle, comprising:
transmitting an oil extraction signal to a gear pump in response to a monitoring instruction;
extracting hydraulic oil from a hydraulic oil tank and conveying the hydraulic oil to the hydraulic oil tank through a pipe in response to the oil extraction signal;
detecting the hydraulic oil in the pipe in real time, generating an oil parameter, and transmitting the oil parameter to a microprocessor; and
comparing the oil parameter with a preset parameter threshold, generating oil quality state information, and displaying the oil quality state information.

10. An electronic device, comprising:
a memory, storing a computer program; and
a processor, wherein
the computer program, when being executed by the processor, causes the processor to perform the online monitoring method for hydraulic oil of a power aerial work vehicle according to claim 9.
